(19) United States
(12) Patent Application Publication
(10) Pub. No.: US 2005/0002629 A1
(43) Pub. Date: Jan. 6, 2005

(54) Method for fabrication of polymer optical waveguide and polymer optical waveguide

(76) Inventors: Satoshi Okamoto, Neyagawa-city (JP); Takeshi Oka, Kobe-city (JP); Hiroshi Tsushima, Takatsuki-city (JP)

Correspondence Address: KUBOVCIK & KUBOVCIK, SUITE 710, 900 17TH STREET NW, WASHINGTON, DC, 20006, US

(21) Appl. No.: 10/839,716

(22) Filed: May 6, 2004

(30) Foreign Application Priority Data
May 8, 2003 (JP) 2003-129830

(51) Int. Cl. G02B 6/10

(52) U.S. Cl. 385/129

(57) ABSTRACT

A method for fabrication of a polymer optical waveguide which has a core layer, a lateral cladding layer, a lower cladding and an upper cladding layer, the method characterized as comprising the steps of coating a polysilane composition containing polysilane and an organic peroxide onto the lower cladding layer to form a polysilane layer which corresponds to the core layer and the lateral cladding layer, and exposing a region of the polysilane layer that corresponds to the lateral cladding layer to an ultraviolet radiation to render the exposed region lower in refractive index than the unexposed region so that the exposed region constitutes the lateral cladding layer and the unexposed region constitutes the core layer.

### BACKGROUND OF THE INVENTION

1. Technical Field

The present invention relates to a method for fabrication of a polymer optical waveguide and also to a polymer optical waveguide.

2. Description of Related Art

Polymer waveguides can be supplied in larger sectional areas and fabricated by simple techniques and at low costs. Because of such advantages, their practical application has been expected. Polymer waveguides are typically built by providing cladding layers in a manner to surround a core layer. In general, the core layer is laterally surrounded by a lateral cladding layer and flanked on its vertical sides by an upper cladding layer and a lower cladding layer. For example, a polymer optical waveguide is proposed which uses a polysilane compound for such core and lateral cladding layers (Japanese Patent Laying-Open No. 2002-311263).

Conventionally, the use of a single-mode optical fiber has been a mainstream of an optical communication system. This has led to extensive research and development of single-mode optical waveguides. A single-mode optical waveguide provides easy control of guided light, is advantageous in miniaturizing a device and is suited for high-speed operation.

However, the recent rapid rise of multi-media demands high-speed transfer of optical signals to offices and houses. Under such circumstances, a multi-mode optical waveguide is gaining an increasing attention as an inexpensive optical part.

Because core and lateral cladding layers in multi-mode optical waveguides generally have large thickness dimensions, the use of conventional polymer materials for those layers results in the failure to achieve uniform photobleaching in formation of the lateral cladding layer, which has been a problem.

### SUMMARY OF THE INVENTION

It is an object of the present invention to provide a method for fabrication of a polymer optical waveguide, which enables short-time and uniform photobleaching in formation of a lateral cladding layer of a polymer optical waveguide even if it is a multi-mode polymer optical waveguide requiring 20 μm or thicker core and lateral cladding layers, as well as providing a polymer optical waveguide.

In accordance with the fabrication method of the present invention, a polymer optical waveguide is fabricated which has a core layer, a lateral cladding layer laterally surrounding the core layer, a lower cladding layer located to underlie the core layer and the lateral cladding layer, and an upper cladding layer located to overlie the core layer and the lateral cladding layer. Characteristically, the fabrication method includes the steps of coating a polysilane composition containing polysilane and an organic peroxide onto the lower cladding layer to form a polysilane layer which corresponds to the core layer and the lateral cladding layer, and exposing a region of the polysilane layer that corresponds to the lateral cladding layer to an ultraviolet radiation to render the exposed region lower in refractive index than the unexposed region so that the exposed region constitutes the lateral cladding layer and the unexposed region constitutes the core layer.

In the present invention, the polysilane composition containing polysilane and an organic peroxide is used to form the polysilane layer which corresponds to the core layer and the lateral cladding layer. When the region of the polysilane layer that corresponds to the lateral cladding layer is exposed to an ultraviolet radiation, an Si—Si bond in polysilane is broken to produce an Si—O—Si bond, resulting in lowering a refractive index of the exposed region. Due to the inclusion of the organic peroxide, the polysilane layer insures an efficient supply of oxygen. This allows short-time and uniform photobleaching in formation of the lateral cladding layer and even enables formation of the lateral cladding layer having a thickness of 20 μm.

Accordingly, in accordance with the present invention, multi-mode polymer optical waveguides such as having 20 μm or thicker core and lateral cladding layers can be fabricated efficiently.

The optical waveguide of the present invention is not limited to multi-mode application but is also applicable as a single-mode polymer optical waveguide provided with core and lateral cladding layers such as having thickness dimensions of smaller than 20 μm.

In the preferred embodiment in accordance with the present invention, the polysilane composition contains a branched polysilane compound and a silicone compound in the ratio (branched polysilane compound:silicone compound) by weight of 30:70-80:20 and also contains an organic peroxide in the amount of 1-30 parts by weight, based on 100 parts by weight of the aforementioned branched polysilane compound and silicone compound.

The polymer optical waveguide of the present invention has a core layer, a lateral cladding layer laterally surrounding the core layer, a lower cladding layer located to underlie the core layer and the lateral cladding layer, and an upper cladding layer located to overlie the core layer and lateral cladding layer. Characteristically, the core and lateral cladding layers are formed of a polysilane composition containing polysilane and an organic peroxide, and the lateral cladding layer has a refractive index rendered lower than that of the core layer by exposure to an ultraviolet radiation that converts an Si—Si bond in polysilane to an Si—O—Si bond.

Because the core and lateral cladding layers incorporated in the polymer optical waveguide of the present invention are formed of the composition containing polysilane and an organic peroxide, an oxygen supply from the organic peroxide to the polysilane accelerates conversion of an Si—Si bond to an Si—O—Si bond while ultraviolet irradiation advances photobleaching in formation of the lateral cladding layer. For this reason, the polymer optical waveguide of the present invention can be fabricated more efficiently than conventional polymer optical waveguides.

The polymer optical waveguide of the present invention is suited for use as a multi-mode optical waveguide with core and lateral cladding layers having a 20 μm or larger thickness dimension, but is also applicable for use as a single-mode polymer optical waveguide without any limitation.

The polysilane composition of the present invention is used to form the core and lateral cladding layers of the polymer optical waveguide of this invention. Characteristically, it contains a branched polysilane compound and a silicone compound in the ratio by weight of 30:70-80:20 and also contains an organic peroxide in the amount of 1-30 parts by weight, based on 100 parts by weight of the aforementioned branched polysilane compound and silicone compound.

The use of the polysilane composition of the present invention enables short-time and uniform photobleaching that results in the formation of a lateral cladding layer having a 20 μm or larger thickness dimension.

### BRIEF DESCRIPTION OF THE DRAWING

FIG. 1 is a sectional view, showing one embodiment of a polymer optical waveguide in accordance with the present invention.

### DESCRIPTION OF THE PREFERRED EXAMPLES

The present invention is below described in more detail.

(Polysilane)

Although either of linear and branched polysilanes can be used in the present invention, the use of branched polysilane is particularly preferred. Linear and branched polysilanes are distinguished from each other by a binding state of an Si atom contained therein. The branched polysilane refers to polysilane containing an Si atom with the number of bonds (binding number) to neighboring Si atoms being 3 or 4. On the other hand, the linear polysilane contains an Si atom with the number of bonds to neighboring Si atoms being 2. Because an Si atom normally has a valence of 4, the Si atom having the binding number of 3 or less, if present among Si atoms in polysilane, is bound to a hydrocarbon group, an alkoxy group or a hydrogen atom, as well as to neighboring Si atoms. The preferred hydrocarbon group is an aliphatic hydrocarbon group having a carbon number of 1-10, either substituted or unsubstituted with halogen, or an aromatic hydrocarbon group having a carbon number of 6-14. Specific examples of aliphatic hydrocarbon groups include chain hydrocarbon groups such as methyl, propyl, butyl, hexyl, octyl, decyl, trifluoropropyl and nonafluorohexyl groups; and alicyclic hydrocarbon groups such as cyclohexyl and methylcyclohexyl groups. Specific examples of aromatic hydrocarbon groups include phenyl, p-tolyl, bi-phenyl and anthracyl groups. The alkoxy group may have a carbon number of 1-8. Examples of such alkoxy groups include methoxy, ethoxy, phenoxy and octyloxy groups. If easy synthesis is considered, methyl and phenyl groups are particularly preferred among them. The refractive index can be adjusted by suitable selection of particular polysilane structures. When a high refractive index is desired, a diphenyl group may be introduced. On the other hand, when a lower refractive index is desired, a dimethyl content may be increased.

Preferably, Si atoms having 3 or 4 bonds to neighboring Si atoms constitute at least 2% of a total number of Si atoms present in the branched polysilane. Because the branched polysilane containing less than 2% of such Si atoms and the linear polysilane are both highly crystalline, the use of such highly crystalline polysilanes likely results in the production of microcrystallites in a film. This causes light scattering and lowers transparency.

The polysilane for use in the present invention can be produced by a polycondensation reaction that occurs when a halogenated silane compound is heated in an organic solvent such as n-decane or toluene, under the presence of sodium or any other alkaline metal, to 80° C. or above. Other applicable synthesis methods include an electrolytic polymerization method and those using metallic magnesium and metal chloride.

The branched polysilane within the purpose of the present invention can be obtained by thermal polycondensation of a halosilane mixture containing an organotrihalosilane compound, a tetrahalosilane compound and a diorganodihalosilane compound, wherein the organotrihalosilane and tetrahalosilane compounds are present in the amount of at least 2 mole %, based on the total amount of the halosilane mixture. Here, the organo-trihalosilane compound serves as a source of Si atoms with the number of bonds to neighboring Si atoms being 3, and the tetra-halosilane compound serves as a source of Si atoms with the number of bonds to neighboring Si atoms being 4. The network structure can be identified as by measurement of an ultraviolet absorption spectrum or a nuclear magnetic resonance spectrum for silicon.

Preferably, the respective halogen atoms in the foregoing organotrihalosilane compound, tetrahalosilane compound and diorganodihalosilane compound, for use as raw material of polysilane, are all chlorine atoms. Besides such halogen atoms, the organotrihalosilane and diorganodihalosilane compounds may have a substituent group, examples of which include the above-listed hydrocarbon and alkoxy groups and a hydrogen atom.

The branched polysilane is not particularly specified in type, so long as it is soluble in an organic solvent and can be coated to form a transparent film. Such organic solvents are preferably based on hydrocarbons having carbon numbers of 5-12, halogenated hydrocarbons and ethers.

Examples of hydrocarbon-based organic solvents include pentane, hexane, heptane, cyclohexane, n-decane, n-dodecane, benzene, toluene, xylene and methoxybenzene. Examples of halogenated hydrocarbon-based organic solvents include carbon tetrachloride, chloroform, 1,2-dichloroethane, dichloro-methane and chlorobenzene. Examples of ether-based organic solvents include diethyl ether, dibutyl ether and tetra-hydrofuran.

The use of the branched polysilane with a higher branching coefficient results in the higher light transmittance, provided that it has a branching coefficient of at least 2%. Deuterated and partially or wholly halogenated, particularly fluorinated, branched polysilanes can also be used. Therefore, the branched polysilane, if properly selected, restrains absorption of a light at a specific wavelength, shows high light transmittance over a wide wavelength range, enables occurrence with high sensitivity and precision of a refractive index change upon exposure to an ultraviolet radiation, and improves thermal stability of the resulting refractive index.

(Silicone Compound)

A specific example of the silicone compound for use in the present invention is represented by the following general formula: 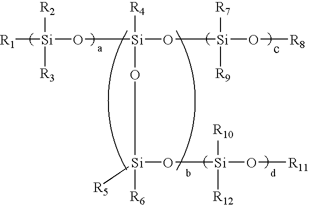
wherein in the formula, R₁-R₁₂ are independently a group selected from the group consisting of an aliphatic hydrocarbon group having a carbon number of 1-10, either substituted or unsubstituted with halogen or a glycidyloxy group, an aromatic hydrocarbon group having a carbon number of 6-12 and an alkoxy group having a carbon number of 1-8; they may be identical or different from each other; and a, b, c and d are independently an integer inclusive of 0 and satisfy a+b+c+d≧1.

More specifically, such silicon compounds result from hydrolytic condensation of dichlorosilane having two organic substituents, called a D-structure, and trichlorosilane having one organic substituent, called a T-structure, either with or without one or more other complementary components, for example.

Specific examples of aliphatic hydrocarbon groups for incorporation in the silicone compound include chain aliphatic hydrocarbon groups such as methyl, propyl, butyl, hexyl, octyl, decyl, trifluoropropyl and glycidyloxypropyl groups; and alicyclic hydrocarbon groups such as cyclohexyl and methyl-cyclohexyl groups. Specific examples of aromatic hydrocarbon groups include phenyl, p-tolyl and biphenyl groups. Specific examples of alkoxy groups include methoxy, ethoxy, phenoxy, octyloxy and ter-butoxy groups.

The types of the preceding R₁-R₁₂ and the values of a, b, c and d are not particularly important and accordingly not particularly specified, so long as the silicone compound is compatible with the polysilane and organic solvent used and together provide a transparent film. If the compatibility is of concern, the silicone compound preferably has the same hydrocarbon group as contained in the polysilane used. For example, in the case where phenylmethyl-based polysilane is used, the use of a phenylmethyl- or diphenyl-based silicone compound is preferred. The silicone compound having at least two alkoxy groups in a molecule, such as the silicone compound in which at least two of R₁-R₁₂ are alkoxy groups having carbon numbers of 1-8, serves as a crosslinking agent. Examples of such silicone compounds include methylphenylmethoxy silicone and phenylmethoxy silicone, each having an alkoxy group content by weight of 15-35%.

The silicone compound for use in the present invention preferably has a molecular weight of not higher than 10,000, more preferably not higher than 3,000.

Also, deuterated and partially or wholly halogenated, particularly fluorinated, silicone compounds can be used. Therefore, the silicone compound, if properly selected, restrains absorption of a light at a specific wavelength, shows high light transmittance over a wide wavelength range, enables occurrence with high sensitivity and precision of a refractive index change upon exposure to an ultraviolet radiation, and improves thermal stability of the resulting refractive index.

(Organic Peroxide)

The organic peroxide for use in the present invention is not particularly specified in type, so long as it is a compound which can efficiently insert oxygen into an Si—Si bond of the polysilane used. The organic peroxide may be in the form of a peroxy ester. The use of benzophenone-containing organic peroxides is particularly preferred. A typical example of the peroxy ester is 3,3′,4,4′-tetra(t-butyl peroxy carbonyl) benzophenone (hereinafter referred to as “BTTB”).

(Polysilane Composition)

In this invention, a polysilane composition containing polysilane and an organic peroxide is used to form a polysilane layer which corresponds to a core layer and a lateral cladding layer. As described earlier, the polysilane composition may contain a branched polysilane compound, a silicone compound and an organic peroxide.

In the case where polysilane is used in the form of a branched polysilane compound, the branched polysilane compound and silicone compound are preferably blended in the ratio (branched polysilane compound:silicone compound) by weight of 30:70-80:20. If the amount of the branched polysilane compound is below the specified range, curing may become insufficient. On the other hand, if it exceeds the specified range, cracking may occur.

The organic peroxide is preferably added in the amount of 1-30 parts by weight, more preferably 5-20 parts by weight, based on 100 parts by weight of the branched polysilane compound and silicone compound. If the amount of the organic peroxide is far below the specified range, the effect of this invention that enables short-time and uniform photobleaching in formation of the lateral cladding layer may not be obtained sufficiently. If it is excessively large, an optical propagation loss of the resulting waveguide may become large.

In the present invention, the polysilane composition is generally supplied in the form of a dilute solution in a solvent capable of dissolving polysilane. Suitable solvents include aromatic hydrocarbons such as benzene, toluene, xylene and methoxybenzene; and ether solvents such as tetrahydrofuran and dibutyl ether. Preferably, the solvent is used within such a range that brings a polysilane concentration to 20-90% by weight.

(Fabrication Process)

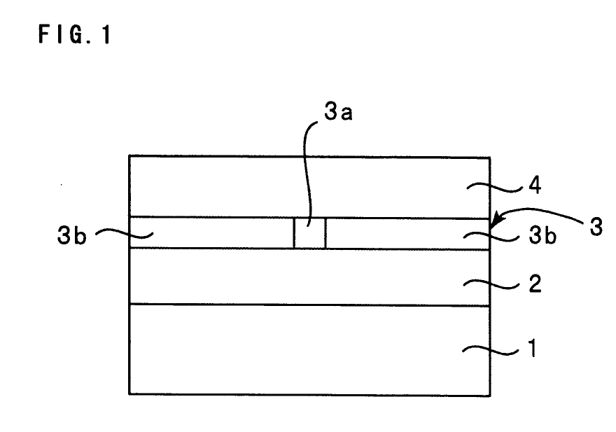

FIG. 1 is a sectional view, showing one embodiment of a polymer optical waveguide in accordance with the present invention.

As shown in FIG. 1, a substrate 1 is located to underlie a lower cladding layer 2. A core layer 3a and a lateral cladding layer 3b are located to overlie the lower cladding layer 2. The core layer 3a extends perpendicular to a paper surface. The lateral cladding layer 3b laterally surrounds the core layer 3a. An upper cladding layer 4 is located to overlie the core layer 3a and the lateral cladding layer 3b.

The polysilane composition is coated onto the lower cladding layer 2 to form a polysilane layer 3 which corresponds to the aforementioned core layer 3a and lateral cladding layer 3b.

Thereafter, a region of the polysilane layer 3 that corresponds to the lateral cladding layer 3b is photobleached by exposure to an ultraviolet radiation. Upon exposure to an ultraviolet radiation, an Si—Si bond of polysilane is broken. The subsequent introduction of oxygen into the broken site from the organic peroxide results in the formation of an Si—O—Si bond. Due to the change of the bond form, a UV-exposed portion of the polysilane layer is rendered lower in refractive index than the unexposed portion which constitutes the lateral cladding layer 3. The ultraviolet radiation preferably has a wavelength in the range of 250-400 nm. Dosage is preferably 0.1-10 J/cm², more preferably 0.1-1 J/cm², per μm thickness of the polysilane layer.

The coated polysilane layer is preferably prebaked at a temperature of 80-150° C. After exposure to an ultraviolet radiation, the polysilane layer is preferably heat treated at a temperature of at least 300° C., more preferably 300° C.-500 ° C. This heat treatment causes decomposition of organic substituens on side chains of polysilane to render it inorganic, resulting in the reduced C—H absorptions in the near infrared region. Accordingly, a loss of the resulting optical waveguide can be reduced to 0.1 dB or less.

In the multi-mode polymer optical waveguide application, the core layer 3a and lateral cladding layer 3b are preferably formed to a thickness of 20 μm or larger, more preferably 20-100 μm.

As described above, photobleaching results in formation of the lateral cladding layer 3b rendered lower in refractive index than the core layer 3a. In the multi-mode polymer optical waveguide application, a difference in refractive index between the core layer 3a and the lateral cladding layer 3b is preferably maintained within about 1-2%. This difference is preferably maintained within about 0.3-0.8% for the single-mode polymer optical waveguide application.

The lower cladding layer 2 and upper cladding layer 4 will suffice if they have refractive indices lower than that of the core layer 3a. As to the refractive index difference, the case of the lateral cladding layer 3b may preferably be referenced.

In the present invention, the polysilane composition may also be used to form the lower cladding layer 2 and upper cladding layer 4. For example, the ratio of the branched polysilane compound to the silicone compound in the polysilane composition may be altered such that the composition, when coated, forms the lower cladding layer 2 and upper cladding layer 4 both lower in refractive index than the core layer 3a.

In the present invention, the substrate having a lower refractive index than the core layer 3a may be used to constitute the lower cladding layer 2 as well.

The following synthesis examples and examples illustrate the practice of the present invention more specifically, but are not intended to be limiting thereof.

### Synthesis Example of Polysilane

400 ml of toluene and 13.3 g of sodium were charged into a 1,000 ml flask equipped with a stirrer. The flask contents were heated in an ultraviolet-shielded yellow room to 111° C. and stirred at a high speed to provide a fine dispersion of sodium in toluene. 42.1 g of phenylmethyldichlorosilane and 4.1 g of tetrachlorosilane were added to the dispersion which was then stirred for 3 hours to effect polymerization. Thereafter, ethanol was added to the reaction mixture to deactivate excess sodium. Subsequent to washing with water, a separated organic layer was introduced into ethanol to precipitate polysilane. The resulting crude polysilane was reprecipitated three times to obtain branched polymethylphenylsilane with a weight average molecular weight of 11,600.

### Example 1

The following procedure was utilized to fabricate a polymer optical waveguide having the construction shown in FIG. 1.

25.0 parts by weight of the branched polymethyl-phenylsilane obtained in the preceding Synthesis Example and 75 parts by weight of a methoxy-containing phenylmethylsilicone resin (product name “DC-3037”, product of Dow Corning Corp.) were dissolved into toluene to provide a polysilane composition (solids content by weight of 67%) This composition was spin coated onto a silicon wafer substrate and then baked at 370° C. to form a 20 μm thick, lower cladding layer.

Subsequently, 47.5 parts by weight of the branched polymethylphenylsilane obtained in the preceding Synthesis Example, 47.5 parts by weight of a methoxy-containing phenylmethylsilicone resin and 5.0 parts by weight of BTTB were dissolved into toluene to provide a polysilane composition (solids content by weight of 60%) . This composition was spin coated onto the lower cladding layer and then prebaked at 120° C. to form a 20 μm thick polysilane layer. The polysilane layer was exposed to an ultraviolet radiation through a photomask located above its region corresponding to a core layer. The ultraviolet irradiation was carried out using an ultraviolet radiation of 300 nm wavelength and 13 mJ/cm² radiation energy. Thereafter, postbaking was carried out at 370 ° C.

By this process, the region corresponding to a lateral cladding layer was photobleached and lowered in refractive index to constitute the lateral cladding layer.

Then, the process used to form the upper cladding layer was followed to form a 20 μm thick, upper cladding layer on the core layer and lateral cladding layer.

### Example 2

The procedure of Example 1 was followed, except that the respective polysilane compositions were formed into 50 μm thick lower cladding layer, 50 μm thick core and lateral cladding layers and 50 μm thick upper cladding layer, to fabricate a polymer optical waveguide.

### Comparative Example 1

50.0 parts by weight of branched polymethylphenylsilane and 50.0 parts by weight of a methoxy-containing phenyl-methylsilicone resin were dissolved into toluene to provide a polysilane composition (solids content by weight of 60%) for use in the formation of the core layer and lateral cladding layer. Otherwise, the procedure of Example 1 was followed to fabricate a polymer optical waveguide.

### Comparative Example 2

The same polysilane composition as in Comparative Example 1 was used to form the core layer and lateral cladding layer. Otherwise, the procedure of Example 2 was followed to fabricate a polymer optical waveguide.

(Exposure Time)

In the preceding Examples 1 and 2 and Comparative Examples 1 and 2, a section of each polysilane layer was observed when its region was photobleached to form the lateral cladding layer. A time an ultraviolet radiation took to arrive at a bottom of the lateral cladding layer was measured. Specifically, after exposure for a certain time period to an ultraviolet radiation, the polysilane layer was postbaked at 370° C. The arrival of an ultraviolet radiation was judged by whether or not a boundary between the core layer 3a and the lateral cladding layer 3b was extended to a top of the lower cladding layer 2.

The exposure time measured in such a manner is given below.
Example 1: 15 minutes
Example 2: 30 minutes
Comparative Example 1: 3 hours
Comparative Example 2: over 5 hours

For Comparative Example 2, “over 5 hours” means that the boundary between the core layer 3a and the lateral cladding layer 3b did not extend to a top of the lower cladding layer 2 even after 5 hours of ultraviolet irradiation.

(NFP Evaluation)

Each of the polymer optical waveguides obtained in Examples 1 and 2 and Comparative Example 1 was cut by a dicing saw to provide a 5 cm long, linear optical waveguide. For the linear optical waveguide, a near-field pattern (NFP) was observed with a transmission mode of a light at a wavelength of 650 nm.

The polymer optical waveguides of Examples 1 and 2 and Comparative Example 1 were fabricated via exposure to an ultraviolet radiation for the above-specified exposure time periods: 15 minutes in Example 1, 30 minutes in Example 2, and 3 hours in Comparative Example 1.

For the optical waveguides of Examples 1 and 2, a clear pattern was observed wherein only the core layer was lightened. On the other hand, for the optical waveguide of Comparative Example 1, a fuzzy pattern was observed as a result of light leakage from the core layer.

(Evaluation of Optical Propagation Loss)

Using the above-prepared linear waveguides, the polymer optical waveguides of Examples 1 and 2 and Comparative Example 1 were measured for propagation loss of a light at a wavelength of 850 nm. The measurement results are given below.
Example 1: 0.1 dB/cm
Example 2: 0.4 dB/cm
Comparative Example 1: immeasurable

The present invention enables short-time and uniform photobleaching in formation of a lateral cladding layer of a polymer optical waveguide even if it is a multi-mode polymer optical waveguide requiring 20 μm or thicker core and lateral cladding layers. Therefore, polymer optical waveguides can be fabricated efficiently.

1. A method for fabrication of a polymer optical waveguide which has a core layer, a lateral cladding layer laterally surrounding the core layer, a lower cladding layer located to underlie the core layer and the lateral cladding layer, and an upper cladding layer located to overlie the core layer and the lateral cladding layer, said method being characterized as comprising the steps of:
coating a polysilane composition containing polysilane and an organic peroxide onto said lower cladding layer to form a polysilane layer which corresponds to the core layer and the lateral cladding layer; and
exposing a region of said polysilane layer that corresponds to the lateral cladding layer to an ultraviolet radiation to render the exposed region lower in refractive index than the unexposed region so that the exposed region constitutes the lateral cladding layer and the unexposed region constitutes the core layer.

2. The method for fabrication of a polymer optical waveguide as recited in claim 1, characterized in that said polysilane composition contains a branched polysilane compound and a silicone compound in the ratio by weight of 30:70-80:20 and also contains said organic peroxide in the amount of 1-30 parts by weight, based on 100 parts by weight of the branched polysilane compound and silicone compound.

3. The method for fabrication of a polymer optical waveguide as recited in claim 1, characterized in that said organic peroxide has a benzophenone group.

4. The method for fabrication of a polymer optical waveguide as recited in claim 1, characterized in that said core layer and lateral cladding layer have a 20 μm or larger thickness dimension.

5. The method for fabrication of a polymer optical waveguide as recited in claim 1, characterized in that said optical waveguide is a multi-mode optical waveguide.

6. A polymer optical waveguide including a core layer, a lateral cladding layer laterally surrounding the core layer, a lower cladding layer located to underlie the core layer and the lateral cladding layer, and an upper cladding layer located to overlie the core layer and the lateral cladding layer,
said optical waveguide being characterized in that said core layer and lateral cladding layer are formed of a polysilane composition containing polysilane and an organic peroxide, and the lateral cladding layer has a refractive index rendered lower than that of the core layer by exposure to an ultraviolet radiation that converts an Si—Si bond in polysilane to an Si—O—Si bond.

7. A polysilane composition for use in the formation of a core layer and a lateral cladding layer of a polymer optical waveguide which includes said core layer, said lateral cladding layer laterally surrounding the core layer, a lower cladding layer located to underlie the core layer and the lateral cladding layer, and an upper cladding layer located to overlie the core layer and the lateral cladding layer,
said polysilane composition being characterized as containing a branched polysilane compound and a silicone compound in the ratio by weight of 30:70-80:20 and also containing an organic peroxide in the amount of 1-30 parts by weight, based on 100 parts by weight of said branched polysilane compound and silicone compound.
